(19) United States
(12) Patent Application Publication
(10) Pub. No.: US 2008/0052488 A1
(43) Pub. Date: Feb. 28, 2008

(54) Method for a Hash Table Lookup and Processor Cache

(75) Inventors: Rolf Fritz, Waldenbuch (DE); Markus Kaltenbach, Leinfelden (DE); Ulrich Mayer, Weil im Schoenbuch (DE); Thomas Pflueger, Leinfelden (DE); Cordt Starke, Weil der Stadt (DE); Jan Van Lunteren, Gattikon (CH)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/742,718

(22) Filed: May 1, 2007

(30) Foreign Application Priority Data
May 10, 2006 (DE) 06113754.3

(51) Int. Cl. G06F 12/00

(52) U.S. Cl. 711/216; 711/207; 711/122

(57) ABSTRACT

The present, invention improves the hash table lookup operation by using a new processor cache architecture. A speculative processing of entries stored in the cache is combined with a delayed evaluation of cache entries. The speculative processing means that for each cache entry retrieved from main memory in a step of the hash table lookup operation it is assumed that it already contains the selected hash table entry. The delayed evaluation means that certain steps of the lookup operation are performed in parallel with others. In advantageous embodiments the invention can also be used in conjunction with a hierarchy of inclusive caches. The preferred embodiments of the invention involve a new approach for a transition rule cache of a BaRT-FSM controller.

### BACKGROUND OF THE INVENTION

The present invention relates to a method and apparatus for caching has table data in a data processing system.

In computer science, a hash table is a data structure that can be used to associate keys with values: In a hash table lookup operation the corresponding value is searched for a given search key. For example, a person's phone number in a telephone book could be found via a hash table search, where the person's name serves as the search key and its phone number as the value. Caches, associative arrays, and sets are often implemented using hash tables. Hash tables are very common in data processing and implemented in many software applications and many data processing hardware implementations.

Hash tables are typically implemented using arrays, where a hash function determines the array index for a given key. The key and the value (or a pointer to their location in a computer memory) associated to the key is then stored in the array entry with this array index. This array index is called the has index. In the case that different keys are associated to different values but these different keys have the same hash index, this collision is resolved by an additional search operation. For example, a linear search in a linked list is performed, where a pointer to the location of the linked list in a computer memory is stored in the array entry, and an entry in the list contains a key-value pair. Each entry in the list is then tested for containing the search key. This method is called chaining.

Another method that can have advantages in certain situations is open addressing, where collisions are resolved by probing: alternate entries in the hash table array are tested in a certain sequence, the probe sequence. Well-known probing sequences include linear probing, quadratic probing, and double hashing. The proportion of entries in the hash table array that are used in called the load factor. The load factors are normally limited to 80% (also when using chaining). A poor hash function can lead to a bad hash table lookup performance even at very low load factors by generating significant clustering. Hence a large portion of computer memory space reserved for the hash table array is unused.

A hash function is well suited for a certain scenario when the chances for collisions are rather small. A good choice for a hash function depends on the type of possible keys. Hash tables with well-suited hash functions often have a pseudo-random distribution of the values in the hash table array, which leads to access patterns to the hash table array that are hard to predict.

In computer science, a cache is a collection of data duplicating original values, where the original data is expensive (usually in terms of access time) to fetch or compute relative to reading the cache. Once the data is stored in the cache, future use can be made by accessing the cached copy, so that the average access time is lower. In general, a cache is a pool of entries. Each entry has a datum, which is a copy of the datum in some backing store. Each entry also has a tag, which specifics the identity of the datum in the backing store of which the entry is a copy. If an entry can be found with a tag matching that of the desired datum, the datum in the entry is used instead. This situation is known as a cache hit. When the cache is consulted and found not to contain a datum with the desired tag, this is known as a cache miss. In the case of a cache miss, most cache implementations allocate a new entry, which comprises the tag just missed and a copy of the data from a backing store.

A processor cache is a cache implementation managed entirely by hardware. It comprises a smaller and faster memory than the main memory used by the processor. It stores copies of the data form the most frequently used main memory locations (a number of main memory cells with consecutive addresses in the main memory). An entry in the processor cache is called a cache line. Each cache line has a tag, which contains the address of the beginning of the memory location in the main memory. When a processor is reading or writing a location in main memory, it first checks whether that memory location is in the cache. This is accomplished by comparing the address of the beginning of the memory location to all tags in the cache that might contain that address.

When using a processor cache, the processor performance is improved by the cache locality principle: In most cases main memory references made in any short time interval tend to use only a small fraction of the total memory. When a main memory location is referenced, it and some of its neighbors are brought from the large slow main memory into the faster processor cache, so that the next time it is used it can be accessed quickly. Except for the need to set up certain parameters and the experience of variable performance penalties in case of cache misses, the operation of processor caches is transparent to any software executed by the processor.

In order to make room for the new entry on a cache miss, a processor cache generally has to evict one of the existing entries. The heuristic that it uses to choose the entry to evict is called the replacement policy. If the replacement policy is free to choose any cache line to hold the copy, the processor cache is called fully associative. If each entry in main memory can go in just one cache line, the cache is called direct mapped. Many processor caches implement a compromise, and are described as set associative. For example, in a two-way set associative processor cache a location in main memory can be stored in either of two cache lines.

State of the art memory technologies used for main memories have the property that an increase in capacity leads to an increase of the access latency of the memory as well. A common approach to deal with this problem is the introduction of multiple levels of processor caches, where, in case of cache miss, (instead of accessing the computer memory) a processor cache of one level is accessing data from a slower cache in the next level. If a memory location can be stored in any cache level, then these processor caches are called inclusive. If a memory location can be stored at most in one cache level, then these processor caches are called exclusive.

A hash table lookup operation executed by a processor typically consists of the following sequential steps:

S1: calculate a hash index based on the search key;

S2: add this hash index to the start address of the hash table entry at the calculated main memory address;

S3: access the selected hash table entry at the calculated main memory address;

S4a: compare the hash table entry that has been retrieved from the main memory with the search key in order to determine if there is a match;

S4b: in case of a match, select the hash table entry as the search result.

In case of a mismatch, further steps are required. If the main memory is complemented by a processor cache, then step S3 is replaced by the following steps:

S3a: check if the calculated main memory address is stored in the processor cache by comparing this address with the cache tag(s);

S3b: in case of a cache hit, retrieve the data from the processor cache; in case of a cache miss, retrieve the data from the main memory instead.

Since the cache locality principle usually does not apply to hash table lookup operations and so the main memory access pattern is usually not predictable for processor caches in the state of the art when hash table lookup operations are performed, cache misses are very likely. Therefore the performance of has table lookup operations directly depends on the latency involved in accessing the main memory in which the data of the hash table is stored.

In order to support both large hash tables in combination with a fast hash table lookup performance on a processor, a main memory architecture is required that offers large storage capacity in combination with low access latency.

### SUMMARY OF THE INVENTION

It is therefore an object of the present invention to provide a method for a hash table lookup that is improved over the prior art and a corresponding computer program and computer program product, and a corresponding processor cache and a corresponding data processing system.

This object is achieved by the invention as defined in the independent claims. Further advantageous embodiments of the present invention are defined in the dependant claims.

The advantages of the present invention are achieved by a speculative processing of entries stored in a processor cache together with the delayed evaluation of cache entries. The speculative processing means that for each cache entry retrieved from main memory in step S3b of the hash table lookup operation it is assumed that it already contains the selected hash table entry. The delayed evaluation means that the steps S1, S2, S3a, and S3b are performed in sequential order but in parallel to the steps S4a and S4b, which are also performed in sequential order.

In case of a cache hit, the total elapsed time for the hash table lookup operation will be the maximum time it takes to perform either the sequence of steps (S1, S2, S3a, S3b) or the sequence of steps (S4a, S4b). This total elapsed time can be significantly shorter than the total elapsed time it takes to perform the sequence of steps {S1, S2, S3a, S3b, S4a, S4b} in the state of the art.

In an advantageous embodiment the invention can also be used in conjunction with a hierarchy of inclusive caches. Only the top-level cache is performing the comparison in step S3a. In another advantageous embodiment the invention can be used with top-level caches involving two-way set associative caches.

### BRIEF DESCRIPTION OF THE DRAWINGS

The present invention and its advantages are now described in conjunction with the accompanying drawings.

FIG. 1: Is a block diagram of a subsystem of a B-FSM controller;

FIG. 2: Is a block diagram of a transition rule vector format;

FIG. 3: Is a block diagram of a subsystem of a B-FSM controller;

FIG. 4: Is a block diagram of a subsystem of a ZuXA controller that comprises a processor cache in accordance to the invention;

FIG. 5: Is an illustrative timing diagram for an embodiment of the invention;

FIG. 6: Is a block diagram of a subsystem of a ZuXA controller that comprises a processor cache in accordance to the invention.

### DETAILED DESCRIPTION

A finite state machine (FSM) is a model of behaviour composed of states, transitions and actions. A state stores information about the past, i.e. it reflects the input changes from the start to the present moment. A transition indicates a state change and is described by a condition that would need to be fulfilled to enable the transition. An action is a description of an activity that is to be performed at a given moment. A specific input action is executed when certain input conditions are fulfilled at a given present state. For example, an FSM can provide a specific output (e.g. a string of binary characters) as an input action. An FSM can be represented using a set of (state) transition rules that described a station transition function.

The preferred embodiments of the invention involve a new approach for a so-called transition rule cache that is part of a co-processor or an accelerator engine based on a programmable B-FSM (BaRT-FSM) controller. BaRT (Balanced Routing-Table Search) is a specific hash table lookup algorithm described in a paper of one of the inventors: Jan van Lunteren, “Searching Very Large Routing Tables in Wide Embedded Memory”, Proc. of GLOBECOM '01, pp. 1615-1619. An example of such an accelerator is the ZuXA accelerator concept that is described in a paper co-authored by one the inventors: Jan van Lunteren et al, “XML Accelerator Engine”, Proc. of First International Workshop on High Performance XML Processing, 2004.

A ZuXA controller is an accelerator that can be used to improve the processing of XML (eXtensible Markup Language) code. It is fully programmable and provides high performance in combination with low storage requirements and fast incremental updates. Especially, it offers a processing model optimized for conditional execution in combination with dedicated instructions for character and string-processing functions. The B-FSM technology described a state transition function using a small number of state transition rules, which involve match and wildcard operators for the current state and input symbol values, and a next-state value. The transition rules are assigned priorities to resolve situations in which multiple transition rules are matching simultaneously.

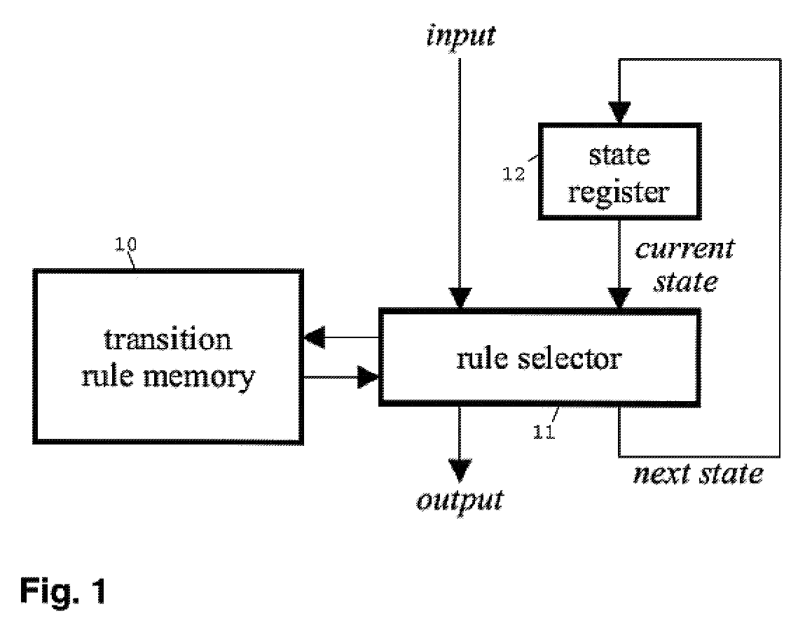

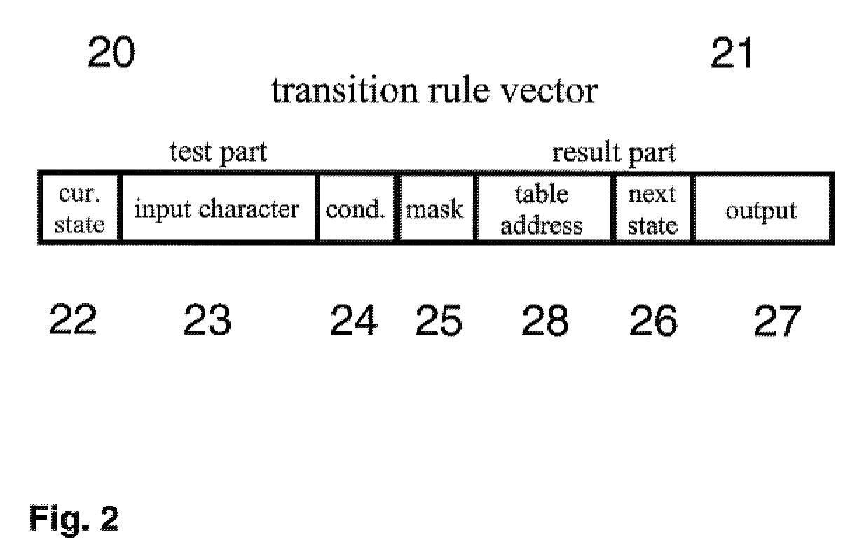

FIG. 1 shows a block diagram of a subsystem of a B-FSM controller. The transition rules are stored in a transition rule memory 10. A rule selector 11 reads rules from the rule memory 10 based on a given input vector and a current state stored in a state register 12. The transition rules stored in the rule memory 10 are encoded in the transition rule vector format shown in FIG. 2. A transition rule vector comprises a test part 20 and a result part 21. The test part 20 comprises fields for a current state 22, an input character 23 and a condition 24. The result part 21 comprises fields for a mask 25, a next state 26, an output 27, and a table address 28.

In a ZuXA controller the input to the rule selector 11 consists of a result vector provided by a component called instruction handler, in combination with a general-purpose input value obtained, for example, from an input port. In each cycle, the rule selector 11 will select the highest-priority transition rule that matches the current state stored in the state register 12 and the input vector. The result part 21 of the transition rule vector selected from the transition rule memory 10 will then be used to update the state register 12 and to generate an output value. The output value includes instructions that are dispatched for execution by the instruction handler component. The execution results are provided back to the rule selector 11 and used to select subsequent instructions to be executed by the instruction handler as described above.

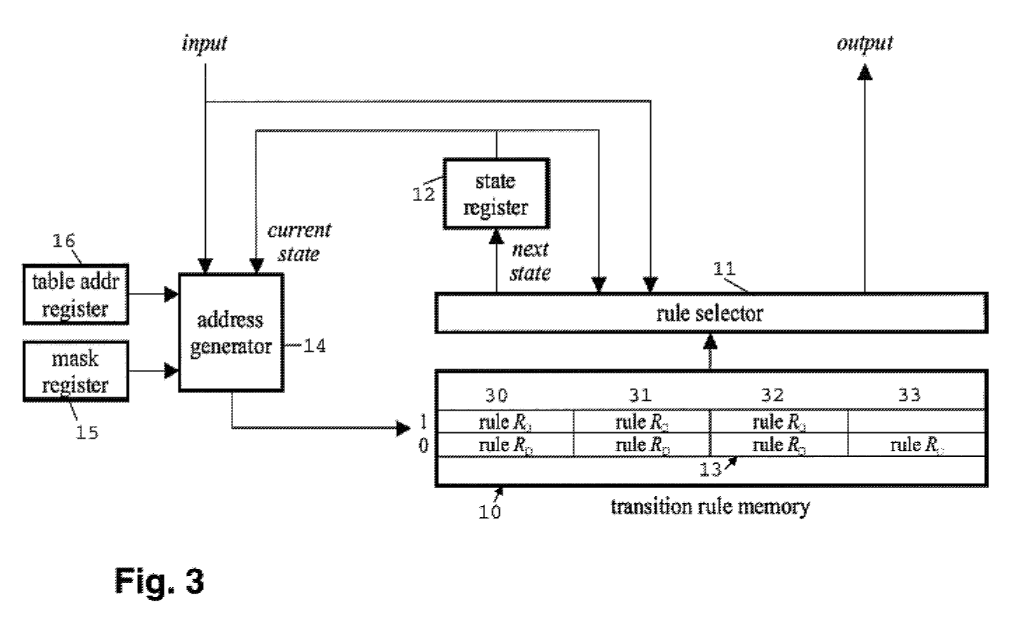

FIG. 3 sows a more detailed block diagram of the B-FSM of FIG. 1. The transition rule memory 10 contains a transition rule table 13 that is implemented as a hash table. Each hash table entry of the transition rule table 13 comprises several transition rules that are mapped to the hash index of this hash table entry. The transition rules are ordered by decreasing priority within a hash table entry. An address generator 14 extracts a hash index from bit positions within the state stored in the state register 12 and input vectors that are selected by a mask stored in a mask register 15. In order to obtain an address for the memory location containing the selected hash table entry in the transition rule memory 10, this index value will be added to the start address of the transition rule table in this memory. This start address is stored in a table address register 16.

The function of the rule selector 11 is based on the BaRT algorithm, which is a scheme for exact-, prefix- and ternary-match searches. BaRT is based on a chaining hash method with a hash function that has the property that the maximum number of collisions for any hash index can be limited by a configurable upper bound. This upper bound is selected to be N=4 in FIG. 3. The width of the transition rule memory 10 allows all N collisions to be resolved using a single memory access. In this case, steps S3a and S3b of the hash table lookup operation involve comparing N=4 transition rule entries 30, 31, 32, 33 contained in each hash table entry 0 and 1 in parallel with the search key. The search key is build from the actual values of the state register 12 and the input vector, while taking potential “don't care” conditions indicated by the condition field 24 of the transition rule entries into account. The first matching transition rule vector is then selected and its result part field 21 is selected to become the search result.

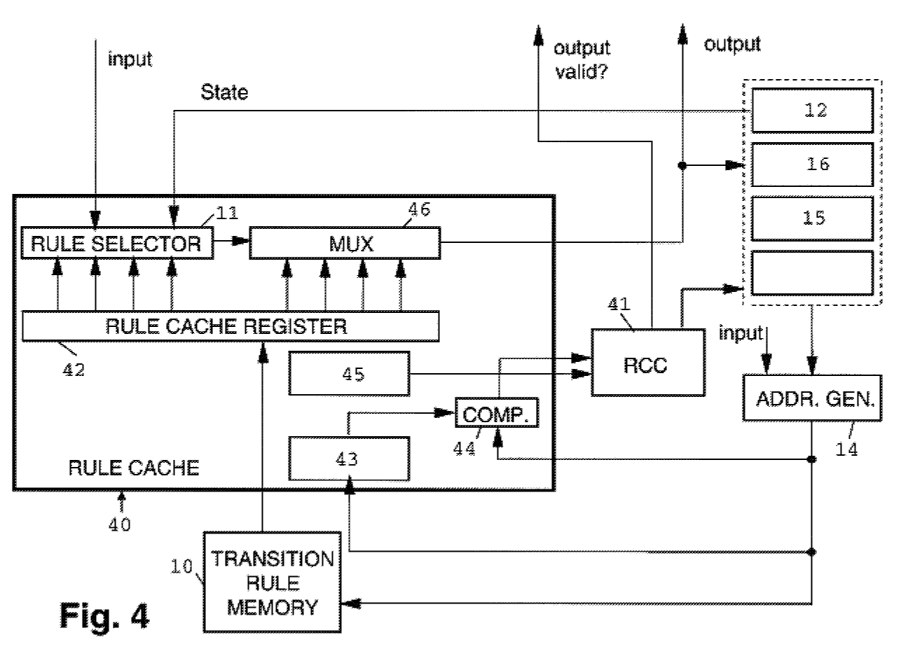

FIG. 4 shows the subsystem of a ZuXA controller from FIG. 3 extended by a processor cache 40 in accordance with the present invention. This processor cache serves as a rule cache 40 and is controlled by a rule cache controller (RCC) 41. The RCC 41 controls also the content that is loaded in the state register 12, the mask register 15, and the table address register 16. A rule cache register 42 comprises a single cache line comprising a copy of an entry from the transition rule table 13.

The rule cache register 42 serves as the memory of the rule cache 40. Therefore the rule cache 40 comprises a single cache line only. A cached address register 43 stores the tag for the cache line. A comparator 44 compares the tag from the cached address register 43 with the address generated by the address generator 14. A valid address register 45 stores bit flags which indicate whether the cached address register contains a valid address and whether the rule cache register 42 contains a valid entry from the transition rule table 13.

The steps of the hash table lookup operation are implemented as follows: The steps S1 and S2 of the hash table lookup operation are performed by the address generator 14. These two steps perform a calculation of the hash index and the memory address, wherein the transition rule memory 10 serves the role of the main memory and the search key is built from a set of registers and an additional input vector. The steps S3a and S3b are implemented by the comparator 44 and controlled by the RCC 41. In these two steps the main memory address is compared with the cache tag. In step S4a the hash table entry is compared with the search key. This step is implemented by the rule selector 11. Each hash table entry can contain four possible matches, which are tested in parallel against the search key. In step 4b a hash table entry is selected in case of a match. This step is implemented by a MUX 46 component, which selects the first hash table entry that matches as the search result. The content loaded to the state register 12, the mask register 15, and the table address register 16 is updated by the RCC 41 based on the search result via the MUX 46. Especially, the search result output vector can be used to generate an instruction vector for the instruction handler.

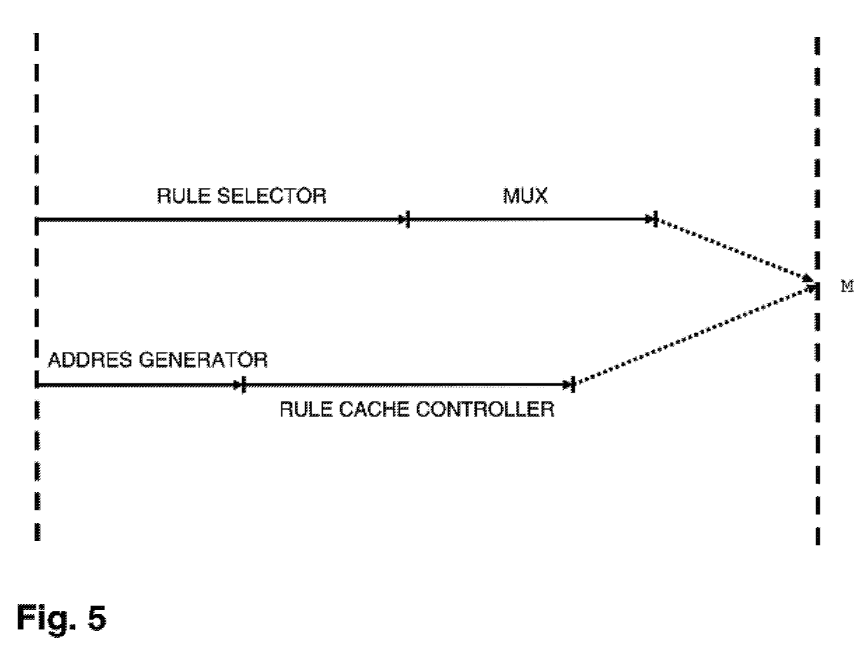

FIG. 5 shows a timing diagram illustrating the parallelism of the sequence of steps (S1, S2, S3a, S3b) and (S4a, S4b). The “address generation” function performed by the address generator 14 precedes the “rule cache controller” function performed by the RCC 41. These function implement the sequence of steps (S1, S2, S3a, S3b). The “rule selector” function performed by the rule selector 11 precedes the “MUX” function performed by the MUX 46. These functions implement the sequence of steps (S4a, S4b). At the moment M that it has been checked that the rule cache 40 contains the desired main memory address (when the sequence of steps (S1, S2, S3a, S3b) is completed) the selected hash table entry will be selected as the search result. Due to this parallelism, the completion of the evaluation step (S1, S2, S3a, S3b) that determines if the cache line contains the desired hash table entry can therefore be considered as delayed. On the other hand the selected hash table entry was obtained through a process step comprising the sequence of steps (S4a, S4b) that can be considered as speculative.

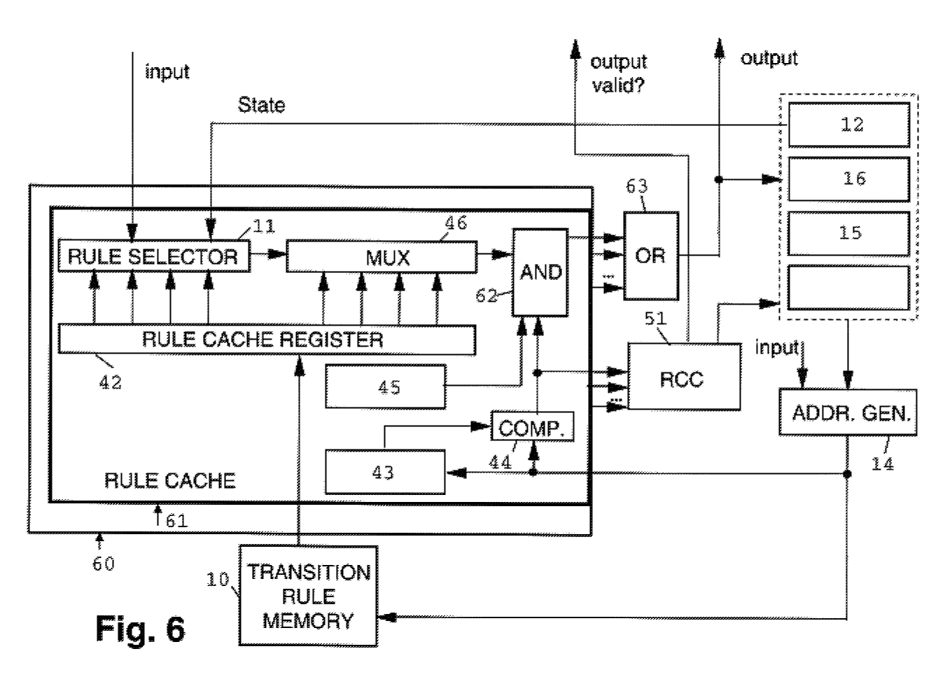

FIG. 6 shows another preferred embodiment of the present invention. In this case the processor cache 60 comprises multiple cache lines. Each cache line is implemented by a rule cache 61. The rules cache 61 is derived from the rule cache 40 in FIG. 4. A RCC 51, derived form the RCC 41 in FIG. 4, is connected to each of these rule caches. For each rule cache the “speculative processings” and the “delayed evaluation” is performed in parallel and in parallel to each of the other rule caches (cache lines).

An additional AND component 62 of a rule cache 61 implements a logical AND function for output signals of the MUX 46, the comparator 44 and the valid address register 45. An OR component 63 implements a logical OR function for all the output signals of all the AND components in the different rule caches. The content of the state register 12, the state mask register 15, and the table address register 16 is updated from the output signals of the OR component 63.

The processor cache 60 exploits the fact that a cache hit can occur in at most one cache line in the following way: Each cache line (a rule cache 61) for which the “delayed evaluation” indicates that there was no cache hit, will reset its output to zero (these are the output signals of the AND component 62). This is also the case when the cache line does not contain a valid address and valid data (as indicated by the content of the valid address register 45). Consequently, only the cache line that detects a cache hit will provide “valid” data at its output signals using a simple logical OR function. These output signals are then provided by the OR component 63. The detection whether there has been a cache hit (one cache line has a match for the search key) or a cache miss(no cache line has a match for the search key) is performed by the RCC 51, which will initiate a read operation on the main memory (the transition rule memory 10) in case of a cache miss.

Several experiments have shown that a significant gain can be achieved in this way for many applications that iterate the same transitions many times. This appears to happen frequently, for example, with applications that “execute” a given transition rule to perform the same processing of a string of input characters (e.g., write in local memory, compare with character string, etc.).

The present invention can also be used in cache hierarchies allowing further performance improvements for hash table lookup operations. For example, in FIG. 4 the rule cache 40 can be used as an L1 (top-level) rule cache. Instead of being connected to the transition rule memory 10 directly, it can be connected to a second level (L2) rule cache, which is then connected to the transition rule memory 10. This L2 rule cache can be implemented by a simple memory storing data, the corresponding addresses and flags indicating their validity. The L2 rule cache is indexed using a selected set of address bits extracted from the actual addresses of the transition rule memory 10 (similar as with a direct-mapped cache). Especially, the L2 rule cache does not contain any compare logic: In case of a cache miss in the L1 rule cache, the L2 rule cache will be accessed using the selected address bits. The corresponding data and address will be directly loaded into the L1 cache, where the actual test is performed in parallel with the “speculative processing”.

Another example for using the invention in cache hierarchies would be to use the processor cache 60 in FIG. 6 as an L1 processor cache that is connected to an L2 processor cache instead of the transition rule memory 10. The L2 processor cache can be a two-way set-associate processor cache and is then connected to the transition rule memory 10. In case the L1 processor cache contains two cache lines only, two cache lines will then be loaded from the L2 processor cache to the L1 processor cache in case of a cache miss in the L1 processor cache. A person skilled in the art knows how to extend this example to L2 processor caches with another kind of set-associativity that correlates to the number of cache lines in the L1 cache.

Especially, in a ZuXA controller the search result can be used to generate an instruction vector for the instruction handler that provides processing results back to the BaRT-FSM as part of an input vector. The instructions contained in the instruction vector can be used for simple (and fast to be implemented) functions that run under tight control of the BaRT-FSM. Examples are character and string processing functions, encoding, conversion, searching, filtering, and general output generating functions.

The invention is not restricted to the B-FSM technology only, but is applicable to a wider range of hash table lookup operations. Also the invention is not restricted to be implemented in hardware entirely. A method in accordance to the present invention can also be implemented as software, a sequence of instructions to be executed on one or more processors of a computer system. While a particular embodiment has been shown and described, various modifications of the present invention will be apparent to those skilled in the art.

1. A method for a hash table lookup in a data processing system comprising a processor cache and a main memory, the method comprising the steps of:
a) calculating a hash index based on a search key;
b) calculating a main memory address from said hash index using the address of a hash table in said main memory;
c) determining if the calculated main memory address is stored in said processor cache;
d) if said calculated main memory address is found in said processor cache, retrieving the hash table entry for said calculated address from said processor cache; and
e) if said main memory address is not found in said processor cache, retrieving said hash table entry from said main memory and storing said hash table entry is said processor cache.

2. The method of claim 1, further comprising the steps of:
f) comparing hash table entries from said processor cache with said search key;
g) when a matching hash table entry is found in said processor cache, selecting the matching hash table entry as the search result; and
wherein the steps a) through e) are performed in parallel to the steps f) and g).

3. The method of claim 1, wherein in step e) said hash table entry is retrieved from a second processor cache, said second processor cache being an inclusive cache for said main memory.

4. A computer program product comprising a computer readable medium embodying program instructions executable by the computer to perform method steps for a hash table lookup, said method steps comprising:
a) calculating a hash index based on a search key;
b) calculating a main memory address from said hash index using the address of a hash table in said main memory;
c) determining if the calculated main memory address is stored in said processor cache;
d) if said calculated main memory address is found in said processor cache, retrieving the hash table entry for said calculated address from said processor cache; and
e) if said main memory address is not found in said processor cache, retrieving said hash table entry from said main memory and storing said hash table entry in said processor cache.

5. The computer program product of claim 4, further comprising program instructions executable by the computer to perform the method steps of:
f) comparing hash table entries from said processor cache with said search key;
g) when a matching hash table entry is found in said processor cache, selecting the matching hash table entry as the search result; and
wherein the steps a) through e) are performed in parallel to the steps f) and g).

6. The computer program product of claim 4, further comprising program instructions executable by the computer to perform the method steps of:
in step e) said hash table entry is retrieved from a second processor cache, said second processor cache being an inclusive cache for said main memory.

7. A processor cache comprising at least one cache line, where the cache lines can arbitrarily store entire hash table entries from a hash table stored in a main memory of a data processing system, said processor cache further comprising input signals for a search key of a hash table lookup operation for said hash table, and means for presenting a matching hash table entry as the search result of said hash table lookup operation, and where said means for presenting a matching hash table entry loads hash table entries of said hash table to cache lines based on the search key but independent from evaluating if a hash table entry stored in a cache line matches the search key.

8. The processor cache of claim 7, where said means for presenting a matching hash table entry loads hash table entries from said main memory.

9. The processor cache of claim 7, where said means for presenting a matching hash table entry loads hash table entries of said hash table from a second processor cache of said data processing system, said second processor cache being an inclusive processor cache for said main memory.

10. The processor cache of claim 9, said second processor being a set-associative cache, and where the processor cache comprises a number of cache lines that correlate to the set-associativity of said second processor cache.
